(19) United States
(12) Patent Application Publication
(10) Pub. No.: US 2009/0153660 A1
(43) Pub. Date: Jun. 18, 2009

(54) SURVEILLANCE SYSTEM AND METHOD INCLUDING ACTIVE ALERT FUNCTION

(76) Inventor: Chia-Lun LIU, Taipei Hsien (TW)

Correspondence Address: Joe McKinney Muncy, PO Box 1364, Fairfax, VA, 22038-1364, US

(21) Appl. No.: 11/959,287

(22) Filed: Dec. 18, 2007

(51) Int. Cl. H04N 7/18

(52) U.S. Cl. 348/143; 348/E07.085

(57) ABSTRACT

A surveillance system including active alert function has a recognition system and an information processing system linking to the recognition system. The recognition system sets a monitoring area and identifies whether a visitor entering the monitoring area is an authorized user and gets monitoring information of the visitor. The information processing system saves the monitoring information and sends the saved information to the authorized user through an output system. Through the invention the authorized user can be actively informed of the monitoring in formation got in the monitoring area to avoid possible risks that might otherwise occur due to non-timely informed of the monitoring information.

### FIELD OF THE INVENTION

The present invention relates to a surveillance system and particularly to a surveillance system including active alert function.

### BACKGROUND OF THE INVENTION

The commonly used conventional security systems can be divided into three types: the first type is a lease burglar-alarm system including security service that has a dedicated data link or phone line connecting to a security control center to alert the security provider when an abnormal signal occurs during a set security period so that security personnel can be dispatched onsite to prevent or limit possible loss or damage caused by burglary or the like; the second type is a purchased burglar-alarm system including security service that has a system design the same as the first type but user retains the burglar-alarm system after the service contract with the security provider is expired; the third type is a purchased burglar-alarm system without including security service. Many different types of burglar-alarm systems are now available on the market, such as video monitor CCD and CCTV systems, door guarding security card or sensor badge card systems, alarm detection light and police-civilian link systems and the like that aim to scare off and thwart intruders. For instance, R.O.C. patent No. M278158 discloses an intelligent door guarding control apparatus.

However, these days burglars are more sophisticated and aware of the operation modes of the existing security systems. They often can discover the response action of an identification unit and security system by doing a number of fake visits and find out the daily activity pattern of a targeted household. Hence they can sabotage or tamper the security and surveillance system while members of the targeted household are absent and invade the house and do pilferage. In the event that the household members come home while the burglar still remains in the house, it could incur a dangerous situation to the household members. Moreover, if the ill-intention person has sabotaged the security and surveillance system and hidden in the house to plot harmful activities, the security and surveillance system cannot alert the household members timely. All these problems have become big issues in the industry yet to be resolved.

### SUMMARY OF THE INVENTION

The primary object of the present invention is to actively provide monitoring information to authorized users. To achieve the foregoing object the present invention provides a surveillance system including active alert function. It includes a recognition system and an information processing system linking to the recognition system. The recognition system aims to set a monitoring area to identify whether visitors entering the monitoring area are authorized and get monitoring information of the visitors. The information processing system stores the monitoring information and sends the stored monitoring information to the authorized users through an output system. The recognition system gets the monitoring information through an image monitoring device. The monitoring information is static or dynamic image information which can be incorporated with voice information. The information processing system further includes an information storage device. In addition to storing the monitoring information, actual environment information or a pre-recorded message also can be saved. These information are delivered to the authorized uses through the output system.

The invention further provides a method to be incorporated with the system mentioned above. It is a surveillance method including active alert function. The method includes: measure of setting a monitoring area: set a monitoring area and get monitoring information when a visitor enters the monitoring area; measure of identifying the visitor: identify and differentiate whether the visitor is an authorized user or an unauthorized user; measure of storing the monitoring information: save the monitoring information of the visitor; and measure of performing active alert: send the saved monitoring information to the authorized user when his/her identification (ID) is being confirmed.

In the measure of storing the monitoring information the monitoring information include unauthorized users or authorized users. In addition, the measure also includes measure of saving pre-recorded messages to save the pre-recorded messages of the authorized users, and a measure of saving actual environment information to save actual environment information. Various types of information saved in measure of storing the monitoring information are delivered through the measure of performing active alert to the authorized users.

By means of the system and method set forth above the authorized users can be actively informed of the information obtained in the monitor area to do proper preparation and avoid the possible risks that might otherwise occur because of lack or delay of the information. Moreover, the invention also integrates the pre-recorded messages to selected users or actively provides the actual environment information to further expand the applications and benefits of the system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of an embodiment of the surveillance system including active alert function of the invention.

FIG. 2 is a flowchart of an embodiment of the method of the invention.

FIG. 3 is a flowchart of another embodiment of the method of the invention including providing pre-recorded messages function.

FIG. 4 is a flowchart of another embodiment of the method of the invention including providing actual environment information function.

FIGS. 5A and 5B are schematic views of an embodiment of the invention in use conditions.

FIGS. 6A and 6B are schematic views of another embodiment of the invention in use conditions including providing pre-recorded messages function.

### DETAILED DESCRIPTION OF THE PREFERRED EMBODIMENTS

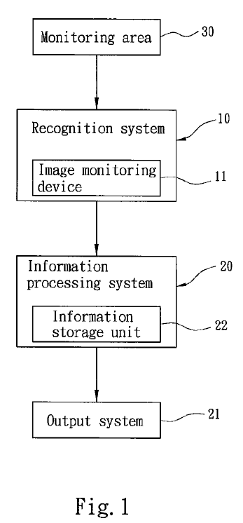

Please refer to FIG. 1 for the structural block diagram of an embodiment of the surveillance system including active alert function of the invention. The surveillance system includes a recognition system 10 and an information processing system 20 linking to the recognition system 10. The recognition system 10 aims to set a monitoring area 30 to identify whether visitors entering the monitoring area 30 are authorized users and get monitoring information of the visitors. The information processing system 20 saves the monitoring information and sends the saved monitoring information to the authorized users through an output system 21.

The recognition system 10 gets the monitoring information through an image monitoring device 11. The image monitoring device 11 is a dynamic image recording device (such as a digital video camera) or a static image recording device (such as a digital camera). The monitoring information captured by the image monitoring device 11 may be static image information (such as photos) or dynamic image information (such as motion pictures). The static and dynamic image information may be incorporated with voice information. In addition, the monitoring information may further include time records. Hence the image monitoring device 11 can capture data of suspected persons or conditions in the monitoring area 30. The recognition system 10 also can judge the identifications of persons or visitors appeared in the monitoring area 30, and differentiate whether they are authorized users or unauthorized users. The recognition system 10 may be coupled with an iris recognition system, facial recognition system, pacing recognition system, outer ear profile recognition system, voice pattern recognition system, thermal induction system, gravity induction system or odor recognition system, or any other system capable of recognizing the identification (ID). More than one system may be coupled to do ID recognition of the visitors.

The information processing system 20 further includes an information storage unit 22 to store the monitoring data captured by the recognition system 10. The information storage unit 22 may be a hard disk drive, flash memory, digital video recorder (DVR) or other memory devices capable of storing the image or video information of the monitoring data. The output system 21 for sending the monitoring information may be an image display device (such as a display), voice broadcasting device (such as a loudspeaker, simplex two-way voice intercom), multimedia player (such as two-way video intercom) or other devices capable of displaying information.

The system previously discussed, aside from serving security surveillance purpose, may also be coupled with other elements to be used in other household applications. The information storage device 22, besides saving the monitoring information, may also store pre-recorded messages. For instance, before a house member leaving home he/she can save a pre-recorded message in the information storage unit 22. When another authorized user is identified by the recognition system 10, the system actively delivers output through the output system 21 to the authorized user. The pre-recorded messages may be voice messages, image messages or multimedia messages.

Moreover, the information storage unit 22 can store actual environment information, such as weather conditions, traffic conditions, stock information, instant news, daily horoscopic references, lunar calendar auspice and evil forecasts or other livelihood information. When an authorized user such as a family member is being identified by the recognition system 10 the actual environment information are actively delivered to him/her through the output system 21.

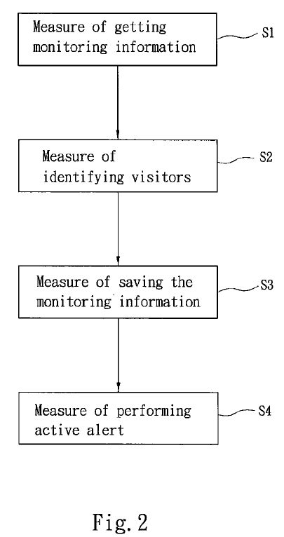

The present invention also provides a monitoring method to actively provide alert function. Referring to FIG. 2 for the process flowchart of the method. It mainly includes the following procedures:

a). measure of getting monitoring information (S1): set a monitoring area 30 and get monitoring information when a visitor enters the monitoring area 30;

b). measure of identifying the visitor (S2): identify and differentiate whether the visitor is an authorized user or an unauthorized user;

c). measure of storing the monitoring information (S3): save the monitoring information of the visitor; and

d). measure of performing active alert (S4): send the saved monitoring information to the authorized user when his/her identification (ID) is confirmed.

In the measure of getting monitoring information (S1) the monitoring information is static image information (such as photos) or dynamic image information (such as motion pictures). The static or dynamic image information may be incorporated with voice information. In addition, the monitoring information may further include time records. The monitoring information is obtained through the image monitoring device 11 of the recognition system 10. After the recognition system 10 has identified the ID of the visitor (S2), he/she is treated as an authorized user or unauthorized user. The obtained monitoring information is transmitted to the information processing system 20 and saved in the information storage unit 22 including that of the authorized user and unauthorized user. In the event that the authorized user is identified, the saved monitoring information is sent to the authorized user through the output system 21 to finish the active alert measure (S4).

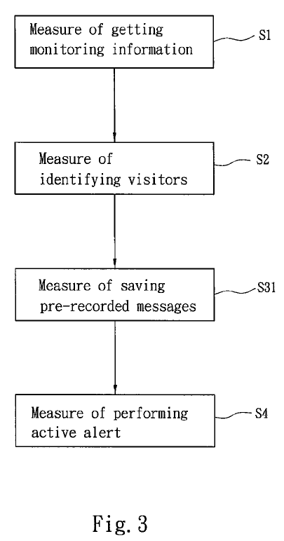

The method of the invention, aside from used on security surveillance, also can be expanded to other applications. The measure of storing the monitoring information (S3) includes measure of storing pre-recorded messages (S31) as shown in FIG. 3 to store pre-recorded messages of the authorized users. The pre-recorded messages are output to the authorized users through the measure of performing active alert (S4). The pre-recorded messages may include voice messages, image messages or multimedia messages.

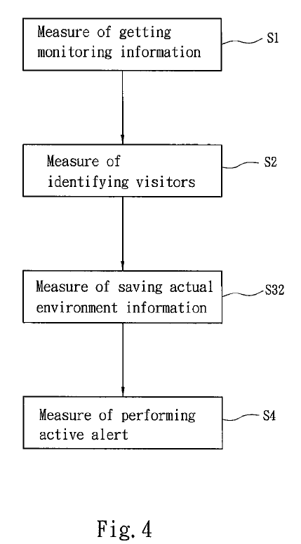

In addition, the measure of storing the monitoring information (S3) may further include measure of storing actual environment information (S32) as shown in FIG. 4 to store actual environment information. The actual environment information is output to the authorized users through the measure of performing active alert (S4). The actual environment information may include weather conditions, traffic conditions, stock information, instant news, daily horoscopic references, lunar calendar auspice and evil forecasts or other livelihood information.

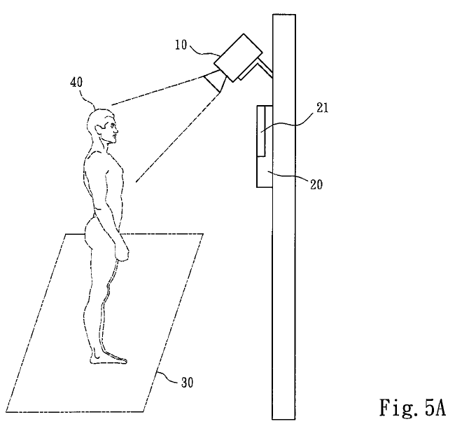

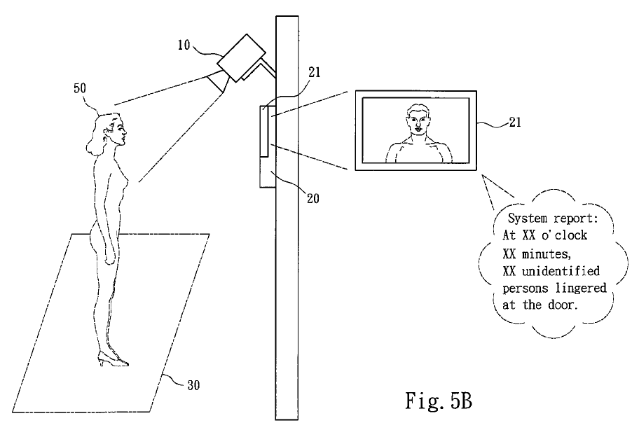

Embodiments of practical applications of the surveillance system of the invention are elaborated as follow. Referring to FIGS. 5A and 5B, the invention is installed at the door of an ordinary house or where people enter and exit. As shown in FIG. 5A, in the event that an unauthorized person 40 enters the monitoring area 30 set by the recognition system 10, the recognition system 10 performs identification of the unauthorized person 40 and gets monitoring information of the unauthorized person 40 through the image monitoring device 11, and transmits the monitoring information to the information processing system 20 for saving. When an authorized person 50 returns at the door the recognition system 10 also performs identification of the authorized person 50 as shown in FIG. 5B. After having confirmed the ID of the authorized person, the information system 20 actively informs the authorized person 50 through the output system 21 the monitoring information previously stored in the information system 20, including image and voice and the like, about the presence of the unauthorized person 40 in the monitoring area 30 while the authorized person 50 is absent.

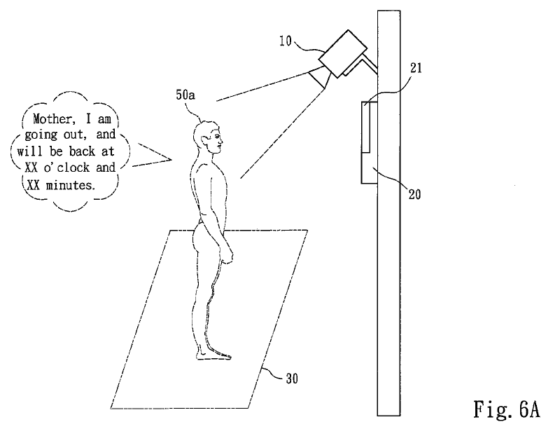

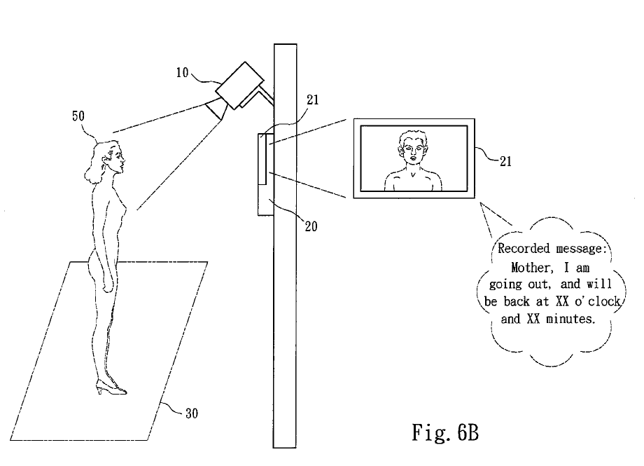

In addition, the invention also allows users to leave messages as desired. Refer to FIGS. 6A and 6B for an embodiment of such an application. When an authorized user 50a (such as a child) is going to leave home as shown in FIG. 6A, he/she can stand in the monitoring area 30 to be identified by the recognition system 10 and leave messages in the information storage unit 22 of the information processing system 20, and order the input messages to be sent to other designated authorized person 50 (such as parents). Referring to FIG. 6B, when the other designated authorized person 50 have returned and stood in the monitoring area 30 and identified by the recognition system 10, the information processing system 20 actively sends the recorded message through the output system 21 to the other designated authorized person 50.

As a conclusion, the surveillance system including active alert function of the invention and method can actively identify all visitors entering the monitoring area 30. Through the recognition system 10 the visitors are classified authorized users 50 and 50a, and an unauthorized user 40. And monitoring information is saved in the information storage device 22 of the information processing system 20. Once the IDs of the authorized persons 50 and 50a have been confirmed, the monitoring information generated in the monitoring area 30 are immediately and actively sent to the authorized persons 50 and 50a through the output system 21. Based on the information proper actions can be taken. Moreover, the information storage unit 22 can also store pre-recorded messages of other authorized user 50a and actual environment information related to livelihood to the authorized users 50 and 50a through the output system 21. Thus application scope of the invention can be expanded to reap more benefits. It provides significant improvements over the conventional techniques,

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A surveillance system including active alert function, comprising:
a recognition system which sets a monitoring area and identifies whether visitors entering the monitoring area are authorized users and gets monitoring information of the visitors; and
an information processing system which is linked to the recognition system to store the monitoring information and send the stored monitoring information to the authorized users through an output system.

2. The surveillance system of claim 1, wherein the recognition system gets the monitoring information through an image monitoring device.

3. The surveillance system of claim 2, wherein the image monitoring device is a dynamic image recording device.

4. The surveillance system of claim 2, wherein the image monitoring device is a static image recording device.

5. The surveillance system of claim 1, wherein the monitoring information is static image information.

6. The surveillance system of claim 5, wherein the monitoring information further includes voice information.

7. The surveillance system of claim 1, wherein the monitoring information is dynamic image information.

8. The surveillance system of claim 7, wherein the monitoring information further includes voice information.

9. The surveillance system of claim 1, wherein the monitoring information further includes time records.

10. The surveillance system of claim 1, wherein the information processing system includes an information storage unit to store the monitoring information.

11. A surveillance method including active alert function, comprising the steps of:
setting a monitoring area and getting monitoring information of a visitor who enters the monitoring area;
identifying the visitor and differentiating the visitor as an authorized user and an unauthorized user;
saving the monitoring information of the visitor; and
alerting actively the identified authorized user by sending the saved monitoring information.

12. The surveillance method of claim 11, wherein the monitoring information is static image information.

13. The surveillance method of claim 12, wherein the monitoring information further includes voice information.

14. The surveillance method of claim 11, wherein the monitoring information is dynamic image information.

15. The surveillance method of claim 14, wherein the monitoring information further includes voice information.

16. The surveillance method of claim 11, wherein the monitoring information further includes time records.

17. The surveillance method of claim 11, wherein the step of saving the monitoring information stores the monitoring information of an unauthorized user.

18. The surveillance method of claim 11, wherein the step of saving the monitoring information stores the monitoring information of the authorized user.

19. The surveillance method of claim 11, wherein the step of saving the monitoring information includes storing pre-recorded messages of an authorized user.

20. The surveillance method of claim 11, wherein the step of saving the monitoring information includes storing actual environment information.
